(19) United States
(12) Patent Application Publication
(10) Pub. No.: US 2008/0028470 A1
(43) Pub. Date: Jan. 31, 2008

(54) Systems and Methods for Vulnerability Detection and Scoring with Threat Assessment

(76) Inventors: Mark Remington, Santa Ana, CA (US); Paul Pyryemybida, Mission Viejo, CA (US); Michael Paul Bringle, Irvine, CA (US); Jorge Monasterio, Aliso Viejo, CA (US)

Correspondence Address: MCANDREWS HELD & MALLOY, LTD, 500 WEST MADISON STREET, SUITE 3400, CHICAGO, IL, 60661, US

(21) Appl. No.: 11/828,179

(22) Filed: Jul. 25, 2007

Related U.S. Application Data
(60) Provisional application No. 60/833,237, filed on Jul. 25, 2006.

(51) Int. Cl. G06F 11/27

(52) U.S. Cl. 726/25

(57) ABSTRACT

Certain embodiments of the present invention provide a system for vulnerability detection and scoring with threat assessment including an analysis engine adapted to perform at least one of automated and semi-automated analysis of a computing system of at least one of known threats, vulnerabilities, and risk factors. The analysis engine is further adapted to determine a security score for the computing system based on the analysis and a schedule indicating a severity level for each threat, vulnerability, and risk factor.

### RELATED APPLICATIONS

This application is related to, and claims the benefit of, Provisional Application No. 60/833,237, filed on Jul. 25, 2006, and entitled “A System or Method of Creating Cryptographic Command or Control Channels with Layers of Digital Signature Authentication or Verification of Digital Communications Enabling Remote Control Over, or Distribution of Arbitrary Reprogramming or Reconfiguration Instructions to, One or More General Purpose Programmable Electronic Devices.” The foregoing application is herein incorporated by reference in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention generally relates to measuring the overall threat level of security risks associated with operating a particular computing system.

Current computing systems, such as servers, desktop workstations, and laptops, are vulnerable to attack from a variety of different avenues. For example, worms and polymorphic viruses may overwhelm antivirus software. It may be difficult or impossible for antivirus software to scan the vulnerabilities worms exploit to enter a system, for example. In addition, reactive virus signatures are ineffective against an advanced virus.

Firewalls running on the computing system only prevent some software from being accessed remotely. For example, port blocking is ineffective against attacks on commonly used ports. That is, ports that may be commonly used cannot simply be blocked, leaving open an avenue for an attack. For example, firewalls are useless at preventing port 80 (the port used by the hypertext transfer protocol) attacks.

Intrusion prevention techniques offer improved security but at a high cost. Users cannot afford to lose productivity to excessive security restrictions. In addition, rule and behavior based intrusion prevention systems are complex to configure and maintain.

### BRIEF SUMMARY OF THE INVENTION

Certain embodiments of the present invention provide a system for vulnerability detection and scoring with threat assessment including an analysis engine adapted to perform at least one of automated and semi-automated analysis of a computing system of at least one of known threats, vulnerabilities, and risk factors. The analysis engine is further adapted to determine a security score for the computing system based on the analysis and a schedule indicating a severity level for each threat, vulnerability, and risk factor.

Certain embodiments of the present invention provide a system for vulnerability detection and scoring with threat assessment including a set of assessment rules and an analysis engine adapted to perform a risk assessment of a computing system to determine a security score for a computing system based at least in part on the set of assessment rules. The assessment rules include a schedule indicating a severity level for each threat, vulnerability, and risk factor.

Certain embodiments of the present invention provide a computer-readable medium including a set of instructions for execution on a computer, the set of instructions including a risk assessment routine configured to analyze a computing system to evaluate one or more known threats, vulnerabilities, and risk factors; a security score determination routine configured to determine a security score for the computing system based on the results of the analysis; and a user interface routine configured to present the security score to a user.

### BRIEF DESCRIPTION OF SEVERAL VIEWS OF THE DRAWINGS

FIG. 1 illustrates a system for vulnerability detection and scoring with threat assessment according to an embodiment of the present invention.

FIG. 2 illustrates a screenshot of a user interface according to an embodiment of the present invention.

FIG. 3 illustrates a screenshot of a user interface according to an embodiment of the present invention.

FIG. 4 illustrates a screenshot of a user interface according to an embodiment of the present invention.

FIG. 5 illustrates a screenshot of a user interface according to an embodiment of the present invention.

FIG. 6 illustrates a screenshot of a user interface according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Many attack vectors are well known to the security technical community but are not easily translated to the common user. Looking at the problem of computing security from the inside-out provides an opportunity to develop a platform for assessing the relative security of a computing system without the user having specific advance technical knowledge. By applying the specific knowledge of vulnerabilities and testing for the presence of a given attack vector, certain embodiments of the present invention are able to create a relative “score” or assessment of the security of the computing system.

The assessment of the relative security of the computing system can also be determined by the presence of various commercial security tools such as anti-virus, firewalls, and known Operating System security patches.

The combination of attack vector determination and other security protection measures can then provide a deterministic measure of relative security. The net result being a “security score” that points the user to areas of deficiency and suggestions for remediation.

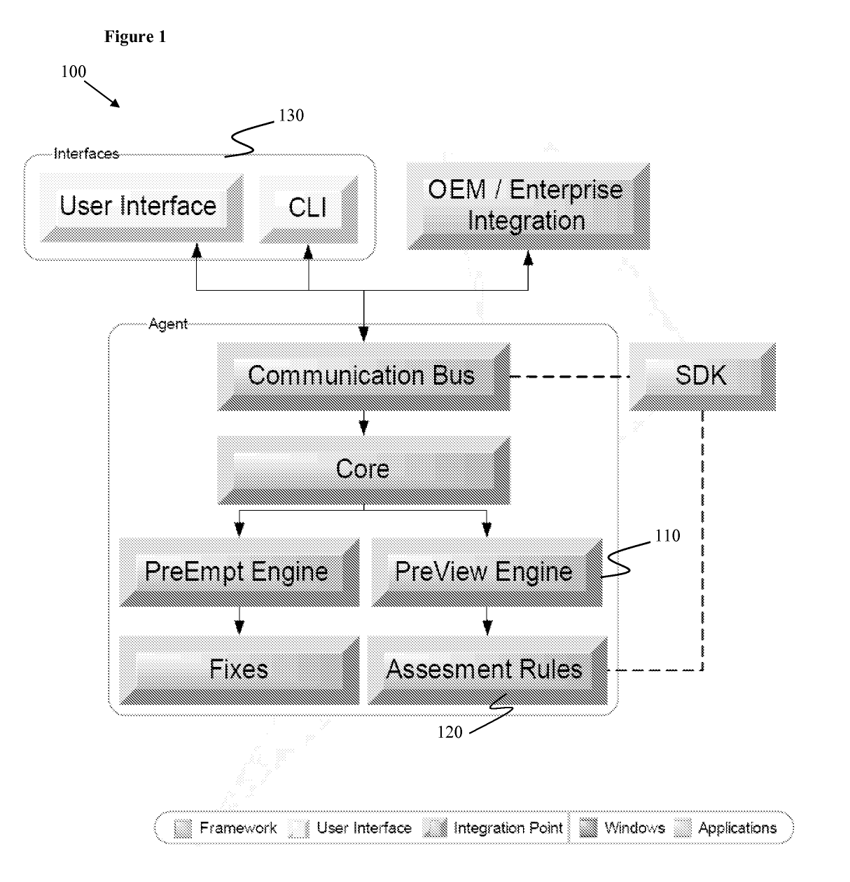

FIG. 1 illustrates a system 100 for vulnerability detection and scoring with threat assessment according to an embodiment of the present invention. The system 100 includes an agent engine 110, assessment rules 120, and a user interface 130.

The agent engine 110 is in communication with the assessment rules 120 and the user interface 130.

In operation, the agent engine 110 provides security testing and risk assessment utilizing the assessment rules 120 to provide a simple security “score” and/or a detailed report to a user using the user interface 130.

The agent engine 110 is adapted to perform a risk assessment on a computing system. The risk assessment may be threat-centric, for example. The risk assessment may include analysis of known threats, vulnerabilities, and/or risk factors for a computing system. The risk assessment may include performing security testing on the computing system, for example. The security testing may include external scans checking for open ports and/or backdoors, for example. The risk assessment may be performed by analyzing the operating system, patch level, system configuration, security software (e.g., antivirus and firewalls), third-party software, and/or manual remediation of the computing system, for example.

The risk assessment may be based on the assessment rules 120, for example. These rules may be easily updated through the remote update mechanism to account for regular changes in attack vectors, commercial security products, and operating system security changes, for example. There may be assessment rules 120, including formula for score creation, based on the relative impact of each category and the type of attack vector, for example. In certain embodiments, the assessment rules 120 are based on assigning a point value of 100 as the highest value. Each category of assessment is assigned a maximum score based on the relative risk each category of protection provides. For example, since attack vectors related to Operating System deficiencies are hidden and expose data to the attacker, that category may have a total possible score of 60. Categories like Operating system security remedies and commercial security products may account for the remaining 40 points. To identify the score of each category a formula that equates the total vulnerabilities divided by the number of known tests and their security weighting may be used. For example, the total number of attack vectors and threats identified with the local computing scan may render 40 out of 60 points (10 threats*1)+(15 threats*2)). In certain embodiments, formula for scoring may vary based on the number and nature of threats published that day and also based on the Operating System security weaknesses.

In certain embodiments, the risk assessment is performed on the same computing system as the agent engine 110 is running. In certain embodiments, the risk assessment is performed by on a computing system remote from the one the agent engine 110 is running on.

The user interface 130 may include a graphic user interface, for example. As another example, the user interface 130 may include a command-line interface. In certain embodiments, the user interface 130 may provide an interface to the agent engine 110 running as a Windows service.

In certain embodiments, the agent engine 110 is part of an agent system. The agent system may include components such as a communication bus for communicating between components of the agent system and external applications. The external applications may communicate with agent engine 110 through interfaces such as an integration interface and/or a software development kit (SDK). In certain embodiments, the user interface 130 may communicate with the agent engine 110 through the communication bus. The integration interface may allow the agent system to be used as part of a larger, enterprise-wide security system. The SDK may allow third-party applications to interface with the agent engine 110.

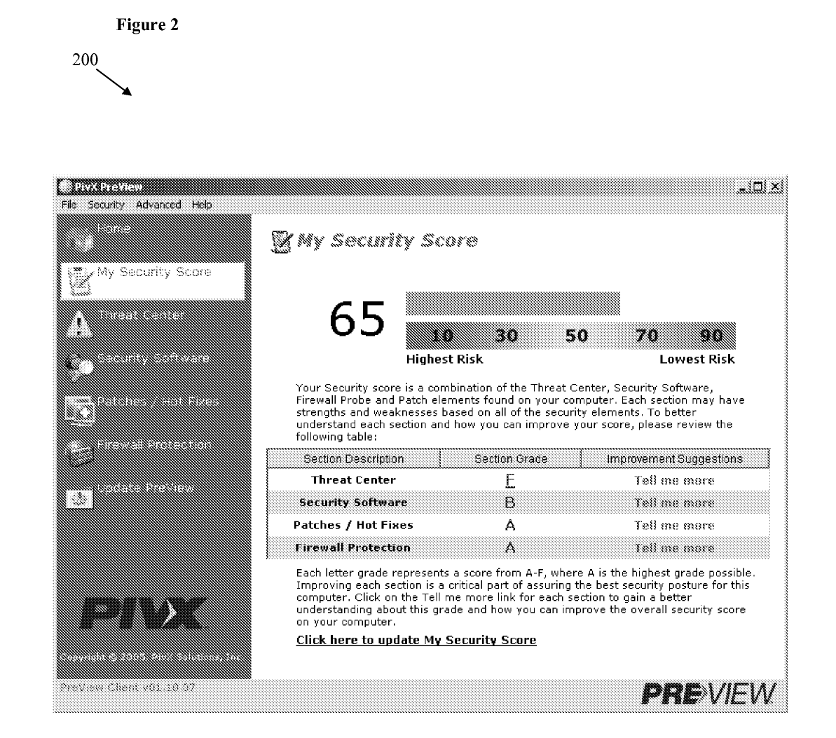

Certain embodiments provide a security “score” based on the risk assessment. The security score provides a metric that quantifies risk for a computing system. The security score may be based on a schedule that indicates the severity of each threat, vulnerability, or risk factor, for example. FIG. 2 illustrates a screenshot 200 of a user interface 130 according to an embodiment of the present invention. More particularly, FIG. 2 illustrates a security score being provided through the user interface 130. In certain embodiments, as illustrated in FIG. 2, more detailed scoring and/or information may be available to the user through the user interface 130.

In certain embodiments, the security score is determined based on a combination of elements or components. For example, the agent engine 110 may be adapted to test aspects of a computing system categorized by “Threat Center,” “Security Software,” “Patches/Hot Fixes,” and/or “Firewall Protection.” In certain embodiments, the user interface 130 is adapted to display scores for the elements, components, and/or categories that make up the security score. The scores for these pieces may be represented numerically or by letter grades, for example.

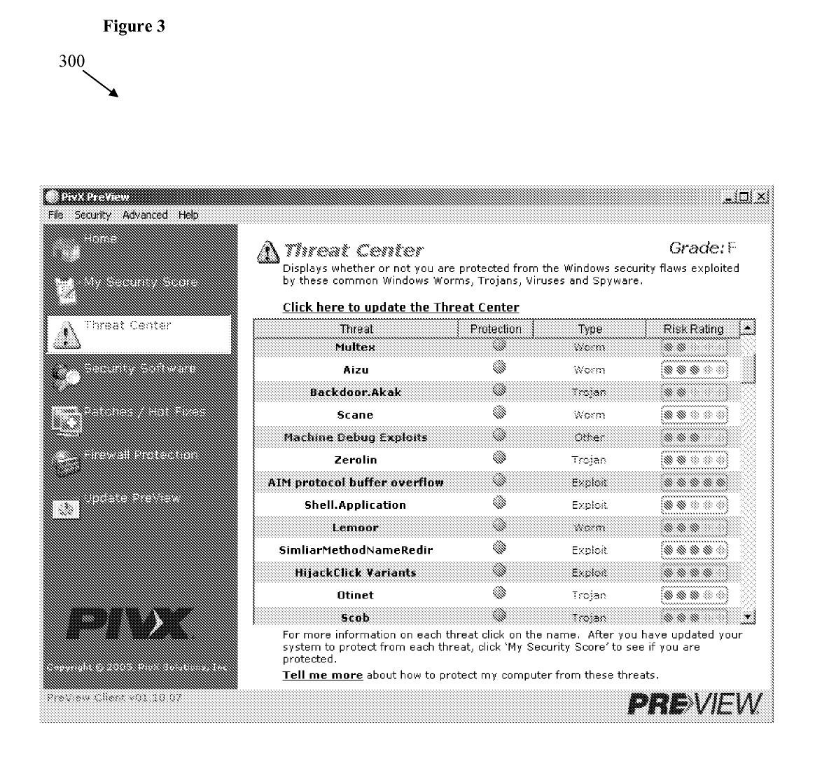

Certain embodiments provide a detailed report based on the risk assessment. The detailed report provides information on one or more factors that are considered in determining a security score, as described above. FIG. 3 illustrates a screenshot 300 of a user interface 130 according to an embodiment of the present invention. More particularly, FIG. 3 illustrates a detailed report relating to various threats that were evaluated as part of the risk assessment. For example, various threats may be listed and identified by type. In addition, indicators may be used to specify whether the computing system that was assessed has protection from the identified threat. Also, indicators may be used to illustrate the relative risk of the particular threat. The indicators may be symbols, images, and/or characters, for example. The indicators may be color coded in certain embodiments.

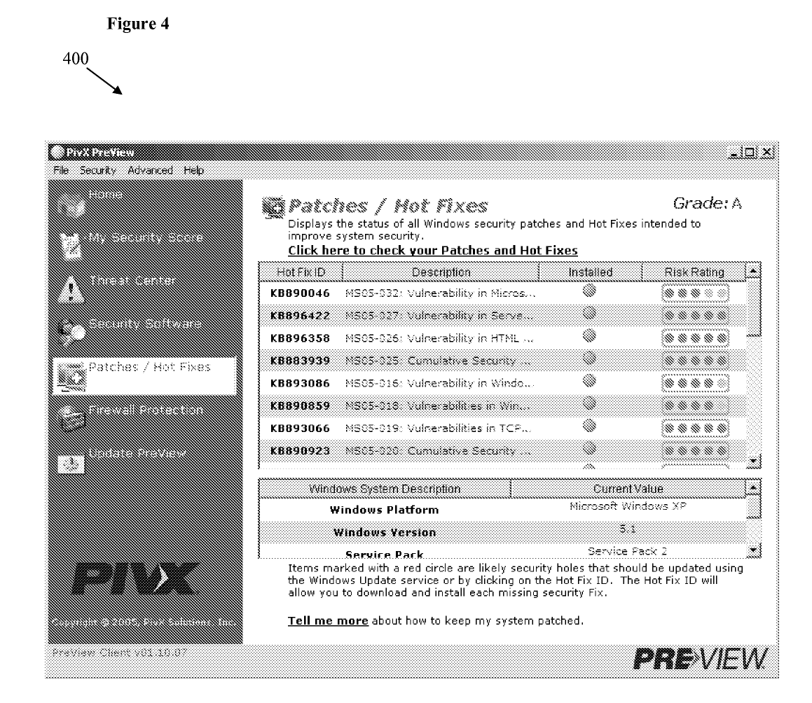

As discussed above, in certain embodiments, the risk assessment considers patches and/or fixes for the operating system and/or applications running on the system. FIG. 4 illustrates a screenshot 400 of a user interface 130 according to an embodiment of the present invention. More particularly, FIG. 4 illustrates various operating system fixes, a brief description of the fix, the installation status of the fix, and the relative risk of not having the particular fix installed. Indicators similar to those discussed above may be used in certain embodiments.

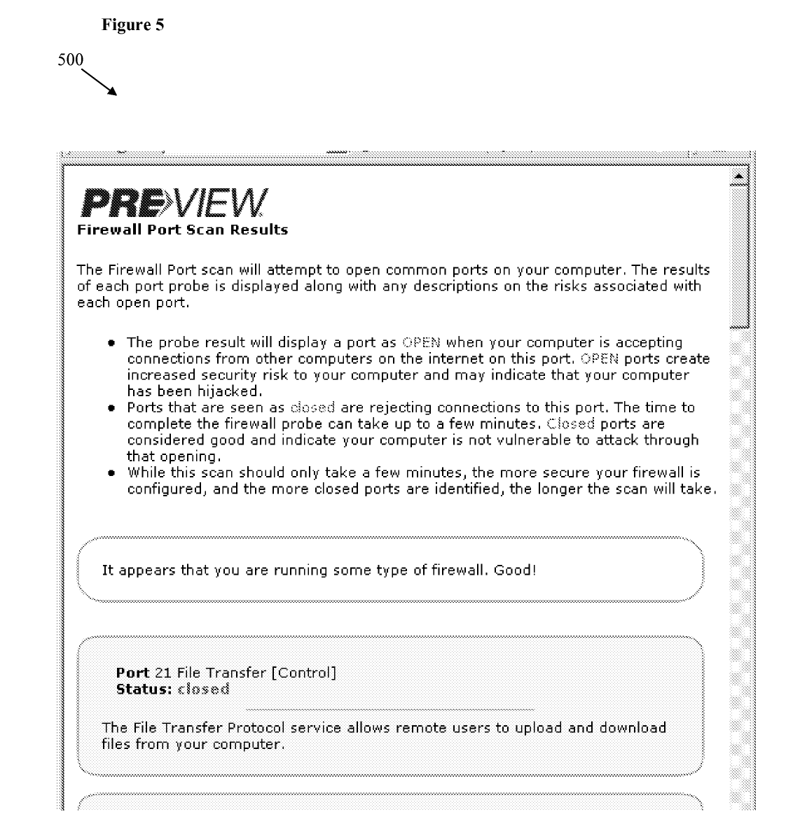

As discussed above, in certain embodiments, the analysis of a computing system may include security testing such as port scanning. FIG. 5 illustrates a screenshot 500 of a user interface 130 according to an embodiment of the present invention. More particularly, FIG. 5 illustrates the results of a port scan of a firewall performed by the analysis engine 110 presented in a detailed report. The report may include an explanation to the user of how to interpret the results, a general summary, and specific ports tested and/or problems identified.

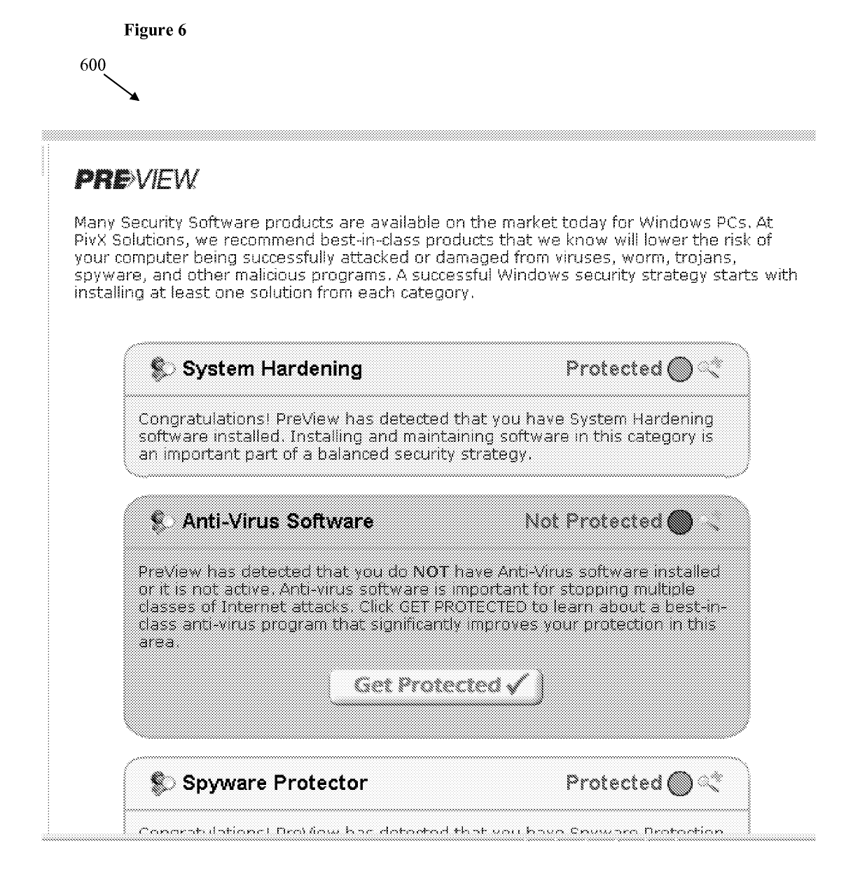

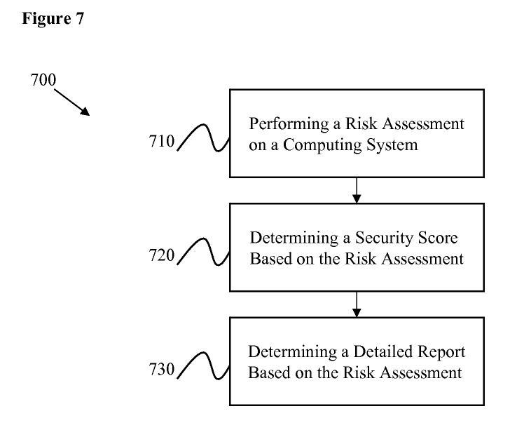

As discussed above, in certain embodiments, the risk assessment includes an analysis of system configuration. This may include, for example, evaluating various security features on the computing system. These security features may include system hardening software, antivirus software, and/or anti-spyware software, for example. FIG. 6 illustrates a screenshot 600 of a user interface 130 according to an embodiment of the present invention. More particularly, FIG. 5 illustrates the results of an evaluation of security features on a computing system performed by the analysis engine 110 presented in a detailed report. The report may include an explanation to the user of how to interpret the results along with a summary of the various features considered, their status, and an evaluation of the particular feature.

In certain embodiments, when a security score is determined, the user interface 130 may be utilized to notify a user or a manager of the computing system. The notification may indicate that the analysis is complete and/or inform the user or manager of the determined security score, for example.

In certain embodiments, recommendations are provided through the user interface 130. The recommendations may include steps to improve the security of the computing system, for example.

In certain embodiments, the risk assessment is automated. The risk assessment may be automated through the evaluation of known attack vectors on the given computing system, for example. In certain embodiments, the risk assessment is semi-automated.

Certain embodiments leverage adaptive desktop defense to provide network-wide threat assessment. For example, certain embodiments allow a information technology staff to perform enterprise-wide security risk assessment and trend analysis. A security metric, such as a “score,” as described above, may be provided for each host as well as an entire network. This may allow weak points in the security posture to be identified and/or corrected.

In certain embodiments, the system 100, through the user interface 130, may notify an automated network admissions control system so that access to a computer network, or access to certain services available through a computer network may be blocked, filtered, and/or restricted as a result of the score. That is, security score may be utilized to determine whether a host can be allowed to access or continue to access a network or service. For example, if the security score for a computing system falls below a threshold determined by a network manager, the computing system may be denied access to the network and/or to one or more services available on the network.

In certain embodiments, the security score is used to permit access to a computer system to a network or services available through a network. For example, a new computing system may be required to receive a certain score before it can be connected to an enterprise network and/or before it is allowed to generate traffic on the network.

In certain embodiments, the security score and/or analysis results are integrated within a system for the detection and/or prevention of electronic intrusions, anomalies, or the exploitation of security vulnerabilities such as those analyzed by the security scoring system. For example, the security score may be used to limit access to a network or service if the score is below some threshold or if certain security software is not installed.

The components, elements, and/or functionality of the system 100 and/or the system 200 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

FIG. 7 illustrates a flow diagram for a method 700 for vulnerability detection and scoring with threat assessment according to an embodiment of the present invention. The method 700 includes the following steps, which will be described below in more detail. At step 710, a risk assessment is performed on a computing system. At step 720, a security score is determined based on the risk assessment. At step 730, a detailed report is determined based on the risk assessment. The method 700 is described with reference to elements of systems described above, but it should be understood that other implementations are possible.

At step 710, a risk assessment is performed on a computing system. The risk assessment may be performed by an agent engine similar to the agent engine 110, described above, for example. The risk assessment may be similar to the risk assessment described above, for example.

The risk assessment may be threat-centric, for example. The risk assessment may include analysis of known threats, vulnerabilities, and/or risk factors for a computing system. The risk assessment may include performing security testing on the computing system, for example. The security testing may include external scans checking for open ports and/or backdoors, for example. The risk assessment may be performed by analyzing the operating system, patch level, system configuration, security software (e.g., antivirus and firewalls), third-party software, and/or manual remediation of the computing system, for example.

The risk assessment may be based on the assessment rules, for example. The assessment rules may be similar to the assessment rules 120, described above, for example.

In certain embodiments, the risk assessment is performed on the same computing system as the agent engine 110 is running. In certain embodiments, the risk assessment is performed by on a computing system remote from the one the agent engine 110 is running on.

At step 720, a security score is determined based on the risk assessment. The risk assessment may be the risk assessment performed at step 710, described above, for example. The security score may be determined by an agent engine similar to the agent engine 110, described above, for example. The security score may be similar to the security score described above, for example.

The security score provides a metric that quantifies risk for a computing system. The security score may be based on a schedule that indicates the severity of each threat, vulnerability, or risk factor, for example.

In certain embodiments, the security score is determined based on a combination of elements or components. For example, the agent engine 110 may be adapted to test aspects of a computing system categorized by “Threat Center,” “Security Software,” “Patches/Hot Fixes,” and/or “Firewall Protection.”

At step 730, a detailed report is determined based on the risk assessment. The risk assessment may be the risk assessment performed at step 710, described above, for example. The detailed report may be determined by an agent engine similar to the agent engine 110, described above, for example. The detailed report may be similar to the detailed report described above, for example. The detailed report provides information on one or more factors that are considered in determining a security score, as described above.

One or more of the steps of the method 700 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for vulnerability detection and scoring with threat assessment, the system including:
an analysis engine adapted to perform at least one of automated and semi-automated analysis of a computing system of at least one of known threats, vulnerabilities, and risk factors, wherein the analysis engine is further adapted to determine a security score for the computing system based on the analysis and a schedule indicating a severity level for each threat, vulnerability, and risk factor.

2. The system of claim 1, wherein the security score is displayed to a user.

3. The system of claim 1, wherein the security score is communicated to a party other than a user.

4. The system of claim 1, wherein the security score is communicated to a Network Admissions Control system that decides whether to permit or deny communications using a data network from the computing system.

5. The system of claim 1, wherein the analysis engine is integrated with a system for detecting or preventing electronic intrusions or the exploitation of security vulnerabilities.

6. The system of claim 1, wherein the analysis engine is integrated with a system for detecting or preventing data structure anomalies or the exploitation of security vulnerabilities.

7. The system of claim 1, wherein the analysis engine is integrated with a system for detecting or preventing exploitation of security vulnerabilities on the computing system.

8. The system of claim 5, wherein at least one of the known threats, vulnerabilities, and risk factors analyzed by the analysis engine is explicitly detected or prevented by using the system.

9. The system of claim 6, wherein at least one of the known threats, vulnerabilities, and risk factors analyzed by the analysis engine is explicitly detected or prevented by using the system.

10. The system of claim 7, wherein at least one of the known threats, vulnerabilities, and risk factors analyzed by the analysis engine is explicitly detected or prevented by using the system.

11. A system for vulnerability detection and scoring with threat assessment, the system including:
a set of assessment rules, wherein the assessment rules include a schedule indicating a severity level for each threat, vulnerability, and risk factor; and
an analysis engine adapted to perform a risk assessment of a computing system to determine a security score for a computing system based at least in part on the set of assessment rules.

12. The system of claim 11, wherein the risk assessment is performed automatically.

13. The system of claim 11, wherein the security score is communicated to a network control system.

14. The system of claim 13, wherein access to a network is determined based on the determined security score.

15. The system of claim 13, wherein access to a service is determined based on the determined security score.

16. The system of claim 11, wherein the security score is presented to a user.

17. The system of claim 11, wherein the analysis engine is further adapted to determine a detailed report based on the risk assessment.

18. The system of claim 17, wherein the detailed report is presented to a user.

19. The system of claim 11, wherein the risk assessment includes analysis of known threats, vulnerabilities, and risk factors.

20. A computer-readable medium including a set of instructions for execution on a computer, the set of instructions including:
a risk assessment routine configured to analyze a computing system to evaluate one or more known threats, vulnerabilities, and risk factors;
a security score determination routine configured to determine a security score for the computing system based on the results of the analysis; and
a user interface routine configured to present the security score to a user.
